(19) United States
(12) Patent Application Publication
(10) Pub. No.: US 2002/0018877 A1
(43) Pub. Date: Feb. 14, 2002

(54) Reduced motion and anti slip pad

(76) Inventors: Calvin L. Woodall, West Monroe, LA (US); Lonnie R. Ketterman, Missouri, CA (US)

Correspondence Address: John M. Harrison, 2139 E. Bert Kouns, Shreveport, LA, 71105, US

(21) Appl. No.: 09/917,030

(22) Filed: Jul. 27, 2001

Related U.S. Application Data
(60) Provisional application No. 60/222,602, filed on Aug. 2, 2000.

(51) Int. Cl. B32B 3/30

(52) U.S. Cl. 428/180

(57) ABSTRACT

A multi-purpose reduced motion and anti-slip pad which is particularly suitable for substantially immobilizing a workstock as a tool is applied to the workstock. In a preferred embodiment the pad is constructed of vinyl plastisol and is characterized by a flexible, durable sheet having multiple, resilient, spaced-apart nodules of selected size and cross-sectional configuration extending from the sheet typically in multiple parallel, diagonal rows. Each of the nodules typically has a flat top surface, and multiple nodules contact and substantially immobilize the workstock as the workstock rests on the pad. In one embodiment, the parallel diagonal rows of the nodules are arranged in columns, with adjacent, parallel columns of nodules separated by a clear lane characterized by an absence of nodules on the sheet and on which a cylindrical workstock can be placed and immobilized. In another embodiment, the diagonal rows of nodules define a continuous field of the nodules on the sheet. In still another embodiment, the nodules are smaller and more numerous to facilitate immobilizing smaller workstocks on the pad.

### CROSS-REFERENCE TO RELATED APPLICATIONS

This application claims the benefit of copending U.S. Provisional Application Ser. No. 60/222,602, filed Aug. 2, 2000.

### BACKGROUND OF THE INVENTION

1. Field of the Invention

This invention relates to anti-slip mats or pads and more particularly, to a multi-purpose reduced motion and anti-slip pad which is capable of a variety of uses and is particularly suitable for gripping and substantially immobilizing or reducing slippage of a workstock as a router or other woodworking tool is manipulated against the workstock. In a preferred embodiment the reduced motion and anti-slip pad is constructed of plastisol and is characterized by a flexible sheet having multiple, spaced-apart, resilient nodules extending from the plane of the sheet typically in multiple, parallel, diagonal rows. Each of the nodules has a selected size and cross-sectional configuration and a typically flat top surface for contacting and substantially immobilizing the workstock as the workstock rests on the pad. In one embodiment the parallel, diagonal rows of multiple nodules are arranged in elongated, parallel columns which are separated by clear rows on the sheet where the nodules are absent and where a cylindrical workstock can be placed for immobilization on the pad. In another embodiment, the adjacent diagonal rows of nodules define a continuous field of the nodules on the sheet. In still another embodiment, the nodules are smaller and more numerous to facilitate immobilizing smaller workstocks on the pad. The slip-resistant texture of the plastisol pad facilitates immobilization of various workstocks on the pad as a router or other woodworking tool is applied to the workstock. Other applications include immobilizing a workstock on the pad for handpainting, immobilizing stained glass on the pad for cutting the glass, and lining drawers with the pad to immobilize and prevent sliding of objects in the drawer.

One of the problems frequently encountered in routing or other woodworking operations is that of inadequate immobilization of a workstock on a surface for the routing or other woodworking operation. Typically, the workstock is secured on a workbench or table using one or multiple C-clamps. However, this technique has drawbacks since it is often difficult to maintain the workstock in the desired position on the workbench using the C-clamps, particularly under circumstances in which the typically flat contact surfaces of the C-clamps do not match the contour of the workstock, as in the case of a cylindrical workstock. Moreover, changing the position of the workstock on the bench or table is cumbersome and time-consuming insofar as this requires that the C-clamp or C-clamps be unfastened, the workstock repositioned on the workbench and the C-clamp or C-clamps adjusted to again secure the workstock on the workbench.

Another method of immobilizing a workstock on a worktable or workbench involves the use of thin foam rubber pads to prevent slippage or movement of the workstock as the routing or other woodworking tool is manipulated against the workstock. However, this technique has drawbacks since the pads gradually become impregnated with sawdust, which causes the pads to become slippery and eventually lose their workstock-immobilizing capability. Moreover, the foam pads eventually tear and become useless due to both inadvertent contact of the rotating router bit with the pads and the stresses placed on the pads during the routing or other woodworking operation. It has surprisingly been found that positioning a workstock on a plastisol pad having multiple resilient nodules with flat surfaces extending from the pad, facilitates complete or substantially reduced slippage or motion of the workstock on the pad as a woodworking tool is applied to the workstock, since the slip-resistant texture of the plastisol causes the pad to grip the workstock as pressure is applied against the workstock. Moreover, the durable plastisol pad is tear-resistant and easy to clean.

2. Description of the Prior Art

Various pads or mats are known in the art for preventing or reducing slippage of a person's feet or an object on a surface. One of these is the “Anti-Slip Mat” described in U.S. Pat. No. 4,336,293, dated Jun. 22, 1982, to Eiden. The Eiden anti-slip mat includes a base layer having a flat bottom face for resting on a supporting surface, and an undulated top face which is characterized by alternating ridges and depressions. The top face of the base layer is coated with an abrasive anti-slip layer which conforms to the undulated contour of the base layer. Another anti-slip surface is provided by the “Surfboard Pad”, disclosed in U.S. Pat. No. 5,435,765, dated Jul. 25, 1995, to Fletcher. The surfboard pad includes multiple pad members each having top and bottom surfaces and multiple, rectangular raised elements extending from the plane of the top surface. Each of the raised elements includes a first raised member which extends from the top surface of the pad member and a second raised member which is smaller than the first raised member and extends stepwise from the top surface of the first raised member. The bottom surfaces of the pad members are affixed to a surfboard, and a surfer stands on the studded top surfaces of the pad members to prevent the surfer from slipping on the surfboard. U.S. Pat. No. 5,707,903, dated Jan. 13, 1998, to Schottenfeld, details a “Decorative Non-slip Liner”, characterized by a non-slip pad and a sheet covering provided on the non-slip pad. The non-slip pad has opposite first and second faces and multiple open cells extending through the pad from the first face to the second face thereof. The pad is formed of a frictionalizing material on the second face which grips a supporting surface and resists movement of the pad in the plane of the surface when the second face of the pad rests on the surface. The sheet covering is provided on the first face of the non-slip pad. A “Fluid Absorption Mat” is described in U.S. Pat. No. 5,834,104, dated Nov. 10, 1998, to Cordani. The mat is constructed of at least one layer of non-woven, fluid-absorbing polypropylene bonded to at least one fluid-impervious backing sheet such as polyester or polyethylene, using a heat-sensitive adhesive. The assembled structure forms a high-strength bonded mat which resists tearing and retains fluids. U.S. Pat. No. 5,906,878, dated May 25, 1999, to Homing, et al., details an “Apparatus and Method for Deterring Slippage of a Slip Cover or Cushion Placed on Furniture”. The apparatus includes a relatively thin layer of foam, rubber, nylon, or cotton wading contained in a fabric exterior cover and which is placed between furniture and a cushion or slip cover to resist slippage of the cushion or slip cover relative to the furniture. The apparatus conforms to the outline of the cushion or slip cover and holds the cushion or slip cover in place to reduce or eliminate friction on the furniture and thus prevent premature wearing of the chair cushion or slip cover. A “Non-Slip Mat or Pad” is described in U.S. Pat. No. 5,997,995, dated Dec. 7, 1999, to Scianna. The mat or pad is formed from a thin sheet of plastic such as polyvinyl, polypropylene, polycarbonate, polystyrene or polyester. The lower surface of the mat or pad is coated with an ultraviolet, water-based or solvent-based ink containing a tackiness agent in the form of an acrylated polymer to impart a non-slip characteristic to the mat or pad. U.S. Pat. No. 6,022,617, dated Feb. 8, 2000, to Calkins, details a “Decorative Non-Slip Liner or Mat”, characterized by a lower laminate layer of nonwoven material, an upper laminate layer of material and an adhesive between the lower and upper layers. A pattern of relatively high-friction material characterized by a high-density matrix of printed latex or polyvinyl chloride projections extends downwardly from the bottom surface of the lower laminate layer for resting on a supporting surface.

Small plastisol pads having multiple dots or nodules extending therefrom and which are cut from large sheets, have long been used as paste applicator pads in the paper bag industry. However, these pads are not used as large sheets for this purpose, and use of the uncut plastisol sheets for attempted immobilization of objects on the pad has revealed that the dots or nodules are typically too long and narrow to satisfactorily facilitate this purpose. Accordingly, the reduced motion and anti-movement pad of this invention represents a significant departure from the known uses of plastisol pads, insofar as the cross-sectional configuration of the nodules on the pad have been modified to a shorter and wider configuration. The modified nodules collectively impart a substantial gripping quality to the pad that is essential for adequate immobilization of objects on the pad.

Accordingly, an object of this invention is to provide a multi-purpose reduced motion and anti-slip pad.

Another object of this invention is to provide a reduced motion and anti-slip pad for preventing inadvertent slippage or movement of a workstock as a tool is applied to the workstock.

Yet another object of this invention is to provide a reduced motion and anti-slip pad which is suitable for a variety of uses including immobilizing a workstock for handpainting, immobilizing stained glass for cutting the glass, and lining drawers to immobilize and prevent sliding of objects in the drawer.

Another object of this invention is to provide a multi-use reduced motion and anti-slip pad characterized by a flexible sheet and multiple, resilient nodules extending from the plane of the sheet in a selected pattern.

Still another object of this invention is to provide a multi-use reduced motion and anti-slip pad characterized by multiple, resilient nodules extending from a flexible sheet in a staggered pattern on the sheet, each of the nodules having a selected size and cross-sectional configuration and a rubbery, slip-resistant texture.

Yet another object of this invention is to provide a reduced motion and anti-slip pad suitable for preventing or reducing slippage of and substantially immobilizing a workstock on a surface, which pad is characterized by a flexible sheet typically constructed of plastisol and having multiple resilient, plastisol nodules of selected size and cross-sectional configuration and a slip-resistant texture, extending from the plane of the sheet for engaging and preventing slippage of the workstock as a router or other woodworking tool is applied to the workstock.

Another object of this invention is to provide a reduced motion and anti-slip pad characterized by a flexible sheet having multiple nodules extending from the plane of the sheet in multiple diagonal rows arranged in parallel columns of nodules, with adjacent, parallel columns of nodules separated by a clear lane characterized by an absence of nodules on the sheet for receiving and substantially immobilizing a cylindrical workstock on the sheet as a router or other woodworking tool is applied to the workstock.

A still further object of the invention is to provide a reduced motion and anti-slip pad typically constructed of plastisol and characterized by multiple, resilient nodules which extend from the plane of a flexible, durable sheet in a continuous field of nodules over the surface of the sheet.

### SUMMARY OF THE INVENTION

These and other objects of the invention are provided in a reduced motion and anti-slip pad which is capable of a variety of uses and is particularly suitable for immobilizing or at least reducing inadvertent motion or slippage of a workstock on a surface as a router or other woodworking tool is applied to the workstock. In a preferred embodiment the reduced motion and anti-slip pad is typically constructed of plastisol and characterized by a flexible, pliant, durable sheet having multiple resilient, spaced-apart nodules extending from the plane of the sheet typically in a staggered pattern in which the nodules are arranged in multiple parallel, spaced-apart, diagonal rows. Each of the nodules has a selected size and cross-sectional configuration and a typically flat top for contacting and substantially immobilizing the workstock as the workstock rests on the pad. The diagonal rows of nodules can be arranged in parallel columns of nodules separated by clear rows on the sheet where the nodules are absent and where a round or cylindrical workstock can be placed for immobilization on the sheet. Alternatively, a continuous field of the nodules is arranged on the sheet for immobilizing the workstock. The slip-resistant texture of the plastisol sheet and nodules provides a grip surface for engaging and substantially immobilizing and preventing inadvertent slippage or motion of the workstock on the pad as the woodworking tool is applied to the workstock.

### BRIEF DESCRIPTION OF THE DRAWINGS

The invention will be better understood by reference to the accompanying drawings, wherein:

FIG. 1 is a perspective view of a preferred embodiment of the reduced motion and anti-slip pad of this invention;

FIG. 2 is a perspective view of another embodiment of the reduced motion and anti-slip pad;

FIG. 3 is an enlarged, perspective view, taken at section line 3 in FIG. 1, of the reduced motion and anti-slip pad;

FIG. 4 is an enlarged, perspective view, taken at section line 4 in FIG. 2, of the reduced motion and anti-slip pad;

FIG. 5 is an enlarged, cross-sectional view, taken along section line 5-5 in FIG. 3, of a nodule element of the reduced motion and anti-slip pad illustrated in FIG. 1, more particularly illustrating a preferred cross-sectional configuration of each nodule;

FIG. 6 is a cross-sectional view, taken along section line 6-6 in FIG. 4, of a nodule element of the reduced motion and anti-slip pad illustrated in FIG. 2, more particularly illustrating an alternative cross-sectional configuration of each nodule;

FIG. 7 is a cross-sectional view of the nodule element of another embodiment of the reduced motion and anti-slip pad, more particularly illustrating another alternative configuration of each nodule;

FIG. 8 is a cross-sectional view of the nodule element of still another embodiment of the reduced motion and anti-slip pad, more particularly illustrating still another alternative configuration of each nodule;

FIG. 9 is a perspective view of the reduced motion and anti-slip pad illustrated in FIG. 1, with a flat wooden workstock shown immobilized on the pad and a router shown engaging the workstock in typical application of the reduced motion and anti-slip pad of this invention;

FIG. 10 is a perspective view of the reduced motion and anti-slip pad illustrated in FIG. 1, with a cylindrical workstock shown immobilized on the pad; and

FIG. 11 is a perspective view of the reduced motion and anti-slip pad illustrated in FIG. 10, with a flat cardboard workstock shown immobilized on the pad as a knife is used to cut the workstock.

### DESCRIPTION OF THE PREFERRED EMBODIMENTS

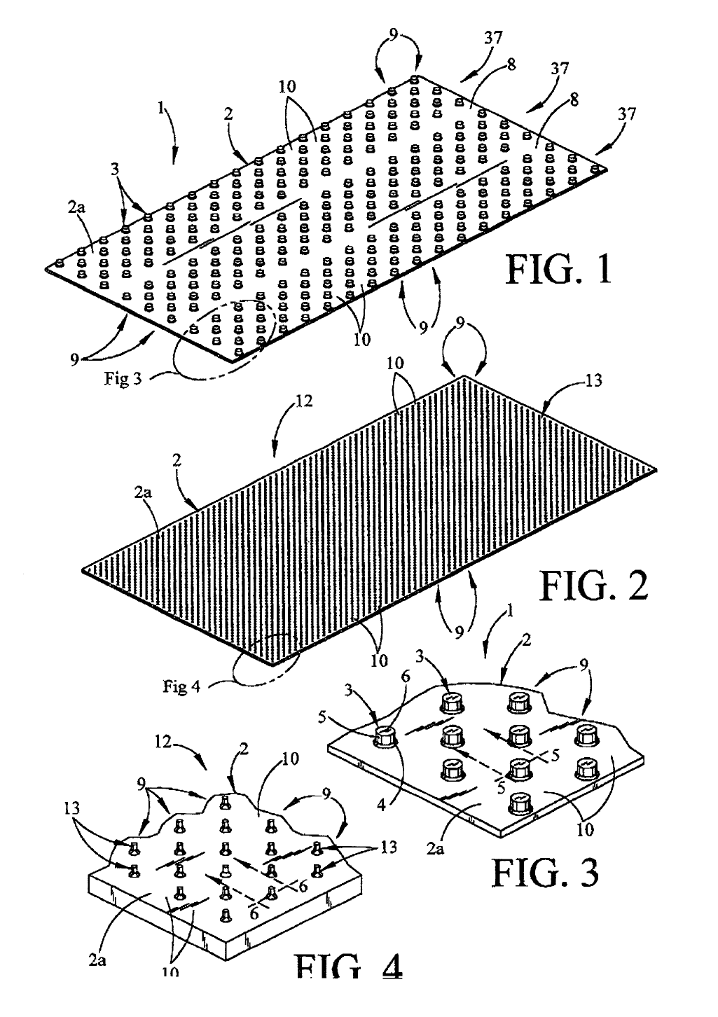

Referring initially to FIGS. 1, 3, 5, 7 and 8 of the drawings, in a preferred embodiment the reduced motion and anti-slip pad, hereinafter referred to as the pad, of this invention is generally illustrated by reference numeral 1. The pad 1, typically constructed of vinyl plastisol using conventional molding techniques well-known to those skilled in the art, is characterized by a typically rectangular, elongated, flexible, pliant sheet 2 having multiple parallel, adjacent, diagonal rows 9 of multiple, resilient nodules 3, each of which extends upwardly from the upper surface 2a of the sheet 2 in spaced-apart relationship with respect to each other. As illustrated in FIG. 5, in a preferred embodiment each of the nodules 3 is typically characterized by a circular base 4 which tapers upwardly from the upper surface 2a of the sheet 2, and a cylindrical nodule body 5 extends upwardly from the base 4 and has a flat top surface 6. Alternatively, as illustrated in FIG. 7, each nodule 3 can be characterized by a tapered body 5, continuous with a tapered base 4 which extends from the upper surface 2a of the sheet 2, and the tapered body 5 has a flat top surface 6. Further in the alternative, as illustrated in FIG. 8 each nodule 3 can be characterized by a tapered base 4 which extends upwardly from the upper surface 2a of the sheet 2, and a tapered body 5 extends in stepwise fashion from the tapered base 4. The tapered body 5 typically has a flat top surface 6, and an annular bevel 7 is defined between the tapered base 4 and the tapered body 5. It is understood that the various cross-sectional configurations of the nodule 3 illustrated in FIGS. 5, 7 and 8 serve as examples only, and each nodule 3 can have any desired cross-sectional shape, but preferably each nodule 3 is wider at the bottom than at the top thereof for reinforcement of the nodule 3 on the sheet 2. Typically, the nodules 3 illustrated in FIGS. 5, 7 and 8 have a base 4 diameter which is slightly larger than the entire height of the nodule 3. In a most preferred embodiment, the nodules 3 illustrated in FIG. 5 have a nodule body 5 which is about 5/16″ in diameter, and the base 4 of the nodules 3 illustrated in FIGS. 7 and 8 is likewise about 5/16″ in diameter. The total height of the nodules 3 in each embodiment is typically about 3/16″. The distance between the edges of adjacent nodules 3 in the diagonal rows 9 on the sheet 2 is typically about ¾″.

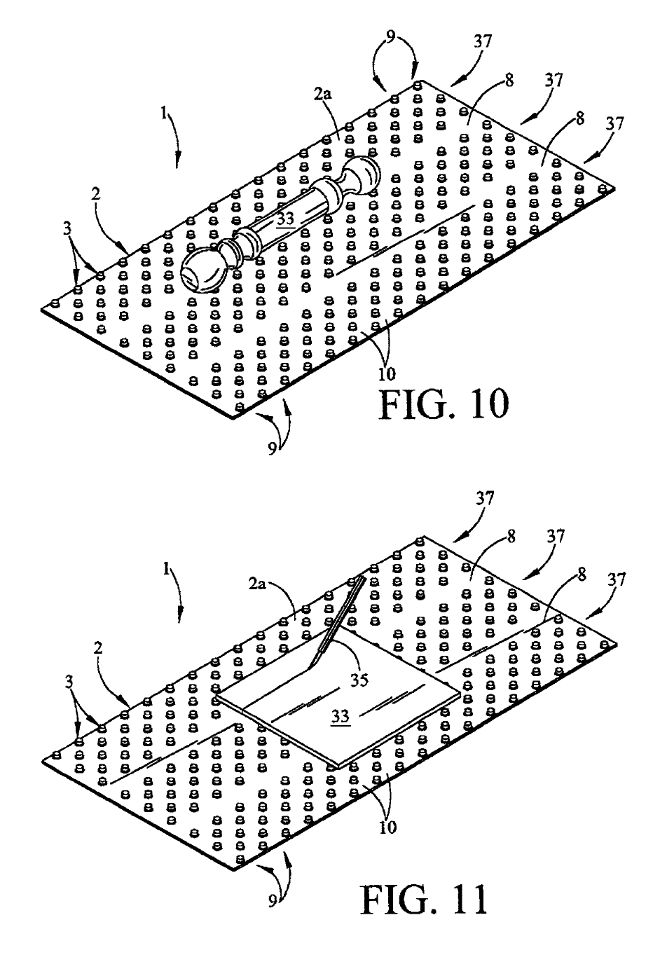

As further illustrated in FIG. 1, in a preferred embodiment the multiple diagonal rows 9 of nodules 3 are arranged in one of multiple elongated, parallel nodule columns 37, with adjacent nodule columns 37 separated by a clear lane 8 which is characterized by an absence of nodules 3 on the sheet 2, the purpose of which clear lanes 8 will be hereinafter described. In an alternative embodiment, the clear lanes 8 can be eliminated by extending the diagonal rows 9 of the nodules 3 across the clear lanes 8, to define a continuous field of the nodules 3 on the sheet 2. Referring next to FIGS. 9-11 of the drawings, in typical application of the pad 1, the sheet 2 is initially placed on a flat surface (not illustrated), with the nodules 3 extending upwardly from the upper surface 2a of the sheet 2. As illustrated in FIG. 9, a flat wooden workstock 33 can then be placed on the flat top surfaces 6 (FIG. 5) of multiple nodules 3 on the sheet 2, and a router 34 can be applied to the workstock 33 to cut a bevel 33a, for example, along an edge of the workstock 33, as illustrated. Alternatively, as illustrated in FIG. 11 a flat cardboard workstock 33 can be placed on multiple nodules 3 and a utility knife 35 used to cut the cardboard workstock 33. It will be appreciated by those skilled in the art that by collectively engaging the bottom surface of the wooden or cardboard workstock 33, in each case the multiple nodules 3 on the sheet 2 provide a large, slip-resistant contact surface area with the workstock 33 which prevents slippage of the workstock 33 on the sheet 2 as the router 34 or utility knife 35 is moved along the workstock 33. As illustrated in FIG. 10, under circumstances in which it is desired to immobilize a cylindrical workstock 33, the workstock 33 is typically placed on one of the clear lanes 8 between adjacent nodule columns 37 of the pad 1, since the nodules 3 typically fail to collectively provide a sufficient contact surface on the cylindrical workstock 33 for adequate immobilization thereof. Accordingly, the slip-resistant textured upper surface 2a of the plastisol sheet 2 prevents inadvertent slippage of the cylindrical workstock 33 on the pad 1 as a woodworking tool (not illustrated) is applied to the workstock 33.

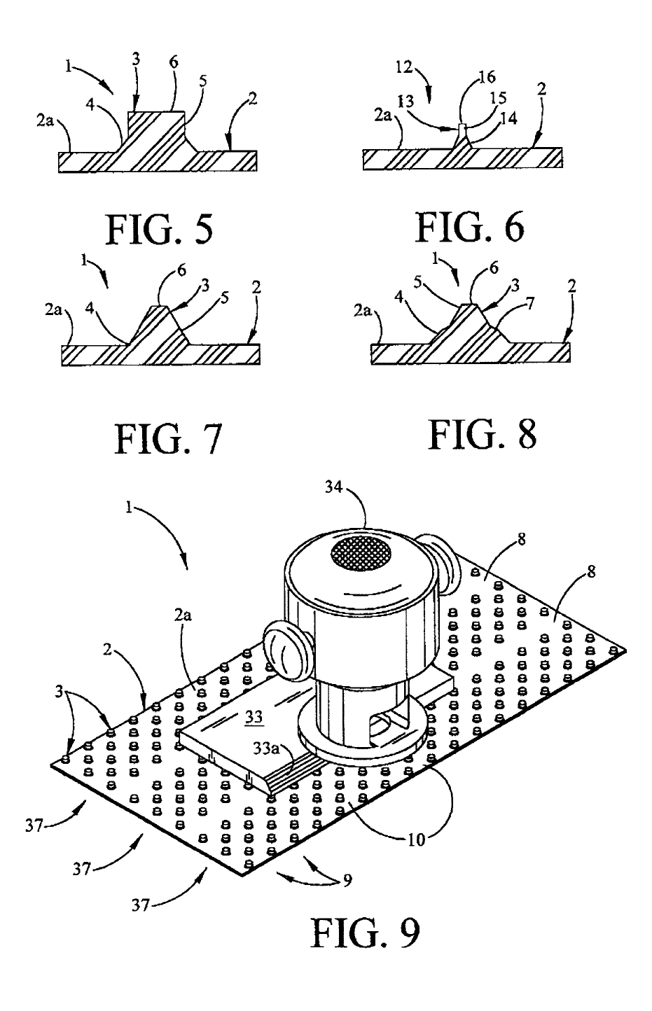

Referring next to FIGS. 2, 4 and 6 of the drawings, in another embodiment of the invention the pad, generally illustrated by reference numeral 12, is characterized by multiple, parallel, diagonal rows 9 of small nodules 13, each of which is characterized by a tapered base 14 which extends upwardly from the upper surface 2a of the sheet 2, and a narrow, cylindrical body 15 extending upwardly from the base 14 and having a flat top surface 16, as particularly illustrated in FIG. 6. The small nodules 13 typically define a continuous field of small nodules 13 on the upper surface 2a of the sheet 2, as illustrated in FIG. 2. Alternatively, the small nodules 13 can be arranged in parallel nodule lanes 37 which are separated by a clear lane 8, as described above with respect to the pad 1 illustrated in FIG. 1. Typically, the nodule base 14 is about 1/16″ in diameter at the upper surface 2a of the sheet 2, and tapers upwardly from the sheet 2 about 1/16″ in height to a diameter of about 1/32″. The body 15 is typically about 1/32″ in diameter and about 1/16″ in height. The distance between the edges of adjacent small nodules 13 in the diagonal rows 9 on the sheet 3 is typically about 3/16″. The pad 12, having the smaller and more numerous and closely-spaced nodules 13 than the pad 1 illustrated in FIG. 1, is typically used for immobilizing smaller workstocks (not illustrated) on the pad 12 during routing or other woodworking operations.

It will be appreciated by those skilled in the art that the reduced motion and anti-slip pad of this invention is capable of a variety of uses including but not limited to immobilization of a workstock during woodworking operations, scrimshaw work or hand-painting, or lining drawers to reduce movement of items in the drawer. Moreover, the durable and easy-to-clean plastisol construction of the pad renders the pad capable of repeated use. While illustrative cross-sectional configurations of the nodules of the pad have been described above in the preferred embodiments, it is understood that the nodules can have various other cross-sectional configurations other than those described above. Preferably, the nodules have a base which reinforces a narrower body portion extending from the base, with a flat top surface on the body portion which facilitates optimal contact of the nodules with the workstock on the pad. While preferred dimensions and spacings of the nodules 3 illustrated in FIGS. 5, 7 and 8 and of the nodules 13 illustrated in FIG. 6 have been described above, it is understood that the nodules can have various sizes and can be distributed in various patterns and in various numbers and spacings on the sheet, depending on the desired immobilizing and movement-reducing function of the pad. Moreover, while the sheet 2 typically has a thickness of at least about 3/32″ in cases in which the pad 1 is constructed for woodworking operations, it is understood that the sheet 2 can be thinner for other applications in which less stress is placed on the pad 1. The preferred durometer, or measure of resiliency, of the sheet 2 and nodules 3 of the pad 1 is in the range of about 35-55, and preferably, about 40-55. It will be further appreciated by those skilled in the art that the pad 1 can be constructed of rubber or plastic materials other than vinyl plastisol, having the preferred resiliency and slip-resistant texture.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, what is claimed is:

1. A reduced motion and anti-slip pad, comprising a sheet and a plurality of nodules extending from said sheet in spaced-apart relationship with respect to each other, said plurality of nodules arranged in a staggered pattern on said sheet.

2. The pad of claim 1 wherein each of said plurality of nodules comprises a base extending from said sheet and a nodule body extending from said base.

3. The pad of claim 1 wherein said plurality of nodules comprises at least two nodule columns and a clear lane separating said at least two nodule columns on said sheet.

4. The pad of claim 3 wherein each of said plurality of nodules comprises a base extending from said sheet and a nodule body extending from said base.

5. The pad of claim 1 wherein each of said plurality of nodules comprises a tapered base extending from said sheet, a tapered body continuous with said tapered base and a flat top provided on said tapered body.

6. The pad of claim 5 wherein said plurality of nodules comprises at least two nodule columns and a clear lane separating said at least two nodule columns on said sheet.

7. The pad of claim 1 wherein each of said plurality of nodules comprises a tapered base extending from said sheet, a tapered body extending from said tapered base, a flat top provided on said tapered body and a bevel provided between said tapered base and said tapered body.

8. The pad of claim 7 wherein said plurality of nodules comprises at least two nodule columns and a clear lane separating said at least two nodule columns on said sheet.

9. A reduced motion and anti-slip pad, comprising a flexible plastisol sheet and a plurality of plastisol nodules extending from said sheet in spaced-apart relationship with respect to each other in a selected pattern on said sheet, each of said plurality of nodules having a flat top surface.

10. The mat of claim 9 wherein each of said plurality of nodules comprises a base extending from said sheet and a nodule body extending from said base, and wherein said flat top surface is provided on said nodule body.

11. The mat of claim 9 wherein said plurality of nodules comprises at least two nodule columns and a clear lane separating said at least two nodule columns on said sheet.

12. The mat of claim 11 wherein each of said plurality of nodules comprises a base extending from said sheet and a nodule body extending from said base.

13. The mat of claim 9 wherein each of said plurality of nodules comprises a tapered base extending from said sheet and a tapered body continuous with said tapered base, and wherein said flat top is provided on said tapered body.

14. The mat of claim 13 wherein said plurality of nodules comprises at least two nodule columns and a clear lane separating said at least two nodule columns on said sheet.

15. The mat of claim 9 wherein each of said plurality of nodules comprises a tapered base extending from said sheet, a tapered body extending from said tapered base and a bevel provided between said tapered base and said tapered body, and wherein said flat top surface is provided on said tapered body.

16. The mat of claim 15 wherein said plurality of nodules comprises at least two nodule columns and a clear lane separating said at least two nodule columns on said sheet.

17. The mat of claim 9 wherein said plurality of nodules is arranged on said sheet in a continuous field of said plurality of nodules.

18. The mat of claim 17 wherein each of said plurality of nodules comprises a base extending from said sheet and a nodule body extending from said base and wherein said flat top surface is provided on said nodule body.

19. The mat of claim 17 wherein each of said plurality of nodules comprises a tapered base extending from said sheet and a tapered body continuous with said tapered base, and wherein said flat top is provided on said tapered body.

20. A method of substantially immobilizing an object on a surface, said method comprising:
(a). providing a pad comprising a resilient sheet and a plurality of resilient nodules extending from said sheet in spaced-apart relationship to each other, each of said plurality of nodules having a substantially flat top;
(b). placing said pad on the surface with said plurality of nodules extending upwardly from said sheet; and
(c). placing the workstock on said plurality of nodules.
